(19) United States
(12) Patent Application Publication
(10) Pub. No.: US 2026/0116178 A1
(43) Pub. Date: Apr. 30, 2026

(54) MOUNTING ARRANGEMENT FOR ATTACHING A RADIATOR MODULE TO A CHASSIS FRAME OF A MOTOR VEHICLE

(71) Applicant: Volkswagen Aktiengesellschaft, Wolfsburg (DE)

(72) Inventor: Mathias DIEDRICH, Wolfsburg (DE)

(73) Assignee: Volkswagen Aktiengesellschaft, Wolfsburg (DE)

(21) Appl. No.: 19/370,607

(22) Filed: Oct. 27, 2025

(30) Foreign Application Priority Data
Oct. 25, 2024 (DE) 10 2024 131 176.2

(51) Int. Cl. B60K 11/04

(52) U.S. Cl. CPC B60K 11/04

(57) ABSTRACT

A mounting arrangement for attaching a radiator module to a chassis frame of a motor vehicle, having two module carriers, each with at least one radiator module receptacle for supporting the radiator module on the module carriers. A first mounting section is provided for mounting the module carriers on the chassis frame, and a second mounting section is provided for mounting the module carriers on a body of the motor vehicle.

This nonprovisional application claims priority under 35 U.S.C. § 119(a) to German Patent Application No. 102024131 176.2, which was filed in Germany on October 25, 2024, and which is herein incorporated by reference.

### BACKGROUND OF THE INVENTION

### Field of the Invention

The invention relates to a mounting arrangement, a motor vehicle, and a method.

### Description of the Background Art

On account of rising cost pressure, efforts are being made to reduce production times for motor vehicles, among other things. One possibility is to use modular design, wherein preferably large modules are created that are preassembled in advance outside of the production line or even outside the plant and then can be delivered to the line. Only the large modules are then connected to one another in the actual carmaking plant.

So that production times can be shortened, it is advantageous when installation of the modules can be carried out as simply as possible by a worker and/or a robot.

Body components/modules, in particular, entail long production times on account of their complexity. In the case of body components, the components at the vehicle front end represent a particular challenge in assembly.

Mounting arrangements for attaching a radiator module to body parts are known from the prior art. The document CN 210027598 U shows a mounting arrangement for a radiator module consisting of a cross member and an additional dust protector. A mounting arrangement for a fan module is known from US 2023/0108092 A1, wherein the arrangement is connected to a body component and additionally has a receptacle for a heat sink. In addition, CN 218316245 U shows a mounting arrangement for attaching a radiator module to a body frame.

Disadvantageous in the known prior art, however, is the difficult installation, which causes increased production times. In addition, the ergonomics are disadvantageous in the case of a complex installation, in particular because the radiator modules generally weigh more than 20 kg.

### SUMMARY OF THE INVENTION

It is therefore an object of the present invention to at least partially overcome at least one of the above-described disadvantages in attaching a radiator module to body parts of a vehicle. In particular, it is an object of the invention to simplify, and thus accelerate, installation of a radiator module on body parts of a vehicle. Furthermore, it is a preferred object to improve the ergonomics of the installation.

The above object is attained by a mounting, by a motor vehicle, and by a method. Of course, features and details that are described in connection with the mounting arrangement according to the invention also apply in connection with the motor vehicle according to the invention and/or in connection with the method according to the invention and vice versa in each case, so mutual reference is and/or can always be made with regard to the disclosure of the individual aspects of the invention.

Provided in an example of the invention is a mounting arrangement for attaching a radiator module to a chassis frame of a motor vehicle, having two module carriers, each with at least one radiator module receptacle for supporting the radiator module on the module carriers, with a first mounting section for mounting the module carriers on the chassis frame and with a second mounting section for mounting the module carriers on a body of the motor vehicle. The radiator module can be installed on a chassis frame of the motor vehicle via the mounting arrangement. The chassis frame in this case serves as a base frame for forming a larger module that can be preassembled by way of modular design. For further installation on the line, the chassis frame is connected to the body and any additional components of the motor vehicle. For simplified assembly, provision is made according to the invention to provide two module carriers that each have at least one radiator module receptacle. Each of the two module carriers consequently includes at least one radiator module receptacle for supporting the radiator module on the module carrier. The radiator module is attached, at least in sections, to the module carrier via the radiator module receptacle. The module carriers and the radiator module therefore preferably are connected to one another in a frictional and/or interlocking manner.

Furthermore, a first mounting section is provided on each of the module carriers so that the module carriers can be connected to the chassis frame. With a second mounting section on each of the two module carriers, the same can be installed on the body of the motor vehicle. The mounting sections for the chassis frame and the body permit a simple attachment of the radiator module to the motor vehicle. In particular by way of modular design, the radiator module can form, together with the chassis frame, a large module for assembly of the motor vehicle. The two mounting sections help to connect the radiator module to the chassis frame in this case, preferably in a first step, and subsequently to connect the chassis frame with the radiator module to the body using the second mounting sections. The mounting arrangement thus forms a sort of interface between the chassis frame with installed radiator module and the body of the motor vehicle.

On account of the high weight of the radiator module (> 20 kg), it is advantageous for ergonomic reasons for this module to be attached to the vehicle as simply as possible. Attachment to the electrical system and/or the drive unit must also be carried out, in addition to mounting on the body. According to the invention, now an attaching of the radiator module to the chassis frame can be accomplished first, via the mounting arrangement, wherein a front end module can then be installed later. The chassis frame also includes the drive unit and/or other electronics of the vehicle, which now can be connected easily without the front end module in the way. The finished, installed module can be attached to the body, and the front end module installed, after the attaching of the radiator module.

The radiator module includes at least one heat sink, in particular made of a metallic material. Aluminum, copper, and/or steel are used by preference here. Moreover, provision can be made that, in addition, a fluid that can be conducted through the heat sink is used for cooling. Moreover, it is preferred that at least one fan is provided. The fan advantageously can be arranged on the heat sink so that the heat sink can work together with the fan.

Provision can be made in a mounting arrangement that at least the first mounting section and/or the second mounting section has at least one receptacle for a fastener. A fastener can be, for example, a screw and/or a bolt. In addition, different or comparable fasteners with which vehicle modules can be connected to one another are also possible. A receptacle according to the invention for a fastener can be, in particular, a hole or recess in the module carrier, through which a fastener can be inserted. Simple and rapid installation is made possible as a result. It is likewise possible that an assembly aid or centering aid is created via the receptacles. Accordingly, it is possible that a fastener is arranged on the chassis frame and can be passed through the receptacle so that a slipping onto the fastener is possible during the course of installation.

It is possible in a mounting arrangement that the module carriers have at least one second radiator module receptacle. The second radiator module receptacle is arranged spaced apart from the first radiator module receptacle on each module carrier, in particular. Via the second radiator module receptacle, the radiator module is consequently installed on two points that are different and spaced apart from one another on the respective module carrier. Preferably, the first and the second radiator module receptacles are designed such that the radiator module can be arranged or mounted in/on the receptacles one after the other. It is especially preferred when all radiator module receptacles together define a rectangle. This means that if one were to draw a line connecting the radiator module receptacles, it would define a rectangle. The module carriers are designed and arranged, in particular, such that the radiator module is connected to the module carriers at its sides, preferably the wide sides.

Provision can further be made in a mounting arrangement that at least one of the radiator module receptacles has a decoupling element or a decoupling element receptacle. During operation of the motor vehicle, in particular of the radiator module, vibrations are produced that can lead to generation of noise which users of the motor vehicle can find bothersome. When an additional fan is employed, vibrations or oscillations are also produced by operation of the fan. The decoupling element can at least reduce the transmission of the vibrations or oscillations from the radiator module to other components of the motor vehicle.

Materials such as EPDM (ethylene propylene diene monomer rubber) and thermoplastic elastomers are advantageous in vibration isolation. These materials offer good damping and are available in different Shore hardnesses, permitting adjustment to the specific requirements of the application. High-quality polyurethane foams with open and closed cells are likewise very effective for vibration damping. They offer good performance in reducing structure-borne noise.

It is furthermore possible in a mounting arrangement that the first mounting section forms a first arm and the second mounting section a second arm, and the first arm is arranged orthogonally to the second arm so that an essentially T-shaped geometry is formed. A T-shaped module carrier is an elongated component that is characterized by its characteristic T-shaped cross section. This geometry gives the carrier high dimensional stability, which makes it especially suitable for the receptacle of the radiator module and as a reinforcing element. The T-shaped cross section has two main components: a flange, which is to say the horizontal part of the T, and a rib, which is to say the vertical part, which in particular offers sufficient space for the mounting receptacles or fasteners.

The horizontal section can additionally serve to provide a bearing surface for the radiator module. This can be helpful, especially during installation of the radiator module, in order to carry the weight of the heat sink.

Provision can also be made in a mounting arrangement that at least one of the radiator module receptacles can be designed as a bearing pin or as a hole. The purpose is to precisely position the radiator module and to fix it in place, which is to say to hold it. Particularly during installation of the heavy radiator module, this is advantageous for ensuring exact alignment and a secure seat. The bearing pin has a cylindrical shank that is introduced into the interior (a receptacle of complementary design) of the radiator module. When it is designed as a hole, the operating principle is analogous, but the hole serves accordingly to receive a bearing pin or peg arranged on the radiator module. In any case, it is advantageous that the radiator module is held securely at this point.

Provision can be made in a mounting arrangement that at least one of the radiator module receptacles has a receiving jaw, wherein a holder of the radiator module can be mounted in the receiving jaw. A receiving jaw here preferably refers to a U-shaped opening, which serves as an entry point or docking point for a mating part with a complementary shape (on the radiator module). This opening preferably is designed such that the mating part can be introduced so as to fit precisely, at least in sections. The side walls of the U-profile offer guidance and retention for the mating part in this case. It is possible for additional elements such as guide grooves, edges, or stops to be integrated in order to exactly position and to secure the mating part. The mounting preferably is accomplished by mechanical locking mechanisms, by screw connections, or by clamping mechanisms, which permit a strong and stable connecting of the two parts. The receiving jaw and the holder thus permit a mounting of the radiator module on the module carriers. In particular, the radiator module can be detachably or reversibly mountable. As a result, it can be removed easily for maintenance or replacement.

Furthermore, provision can be made in a mounting arrangement that the module carriers are connected to one another via a crosspiece. A crosspiece can be a component that serves as a load-bearing and/or connecting element of the two module carriers. In particular, the crosspiece refers to a horizontal member that absorbs and distributes loads. It is thus a transverse connection between the two module carriers, by which means stability is increased and/or possibilities for mounting are created.

With respect to the present invention, it is possible in a mounting arrangement that the crosspiece has a supporting section for the radiator module, by which means the radiator module can be supported on the crosspiece. A crosspiece offers stability, increases the load-carrying capacity, and uniformly distributes the forces that arise. For installation of the radiator module, the crosspiece makes possible an easing of the task for the worker, in particular. To mount the radiator module, the worker can arrange it on the crosspiece, thereby attaining a first positioning. In this way, the mounting on the module carriers, for example via screws, can be simplified.

Furthermore, provision can be made in a mounting arrangement that the module carriers have an interface for mounting a front end module of the motor vehicle. A front end module of a motor vehicle is an assembly that is installed in the front region of the vehicle and incorporates a multiplicity of important components. The module typically includes parts such as the bumper, headlights, air conditioning condenser, impact beam, longitudinal member, engine hood, fenders, and/or sensors for assistance systems (such as radar and cameras). It serves to simplify the installation processes and to reduce production costs. The front end module is preassembled in a separate assembly station or at a supplier. The completely preassembled module normally is delivered just-in-time to the vehicle production line. The module is positioned on the vehicle body, often with the aid of robots or special hoists. The module carriers according to the invention, which are mounted on the chassis frame and then connected to the front end module via the interface, are provided for this purpose. The module is preferably screwed or clipped to the vehicle structure.

The aforementioned object is furthermore attained by a motor vehicle according to the invention with a chassis frame and a body and also with a mounting arrangement for attaching a radiator module to the chassis frame of the motor vehicle. The mounting arrangement permits a simple attachment to the chassis frame and to the body.

As a result, the same advantages arise with respect to a motor vehicle according to the invention as have already been described with respect to a mounting arrangement according to the invention.

The aforementioned object is furthermore attained by a method according to the invention for attaching a radiator module to a chassis frame of a motor vehicle, having the steps: mounting the module carriers on the chassis frame via a first mounting section of the module carriers, fitting the radiator module into the module carriers, connecting functional interfaces of the radiator module to the motor vehicle, connecting the chassis frame to a body of the motor vehicle, and mounting the module carriers on the body of the motor vehicle.

The method steps in this case are not limited to the order as listed. Furthermore, steps can be carried out partly simultaneously and in any order.

In the first step, the module carriers, which serve as carrier systems for various vehicle components such as the radiator module, are initially mounted on the chassis frame. The chassis frame is a structural component of the vehicle that establishes the connection between drive, chassis, and body. The drive/the drive unit preferably is already arranged on the chassis frame in this case.

During the process, the module carriers are aligned precisely and positioned at defined mounting points of the chassis frame, here the mounting sections. They are generally fixed in place by screws, bolts, or specialized holders. These fastening elements provide the necessary stability and reliability. Care is taken that the module carriers are correctly positioned in order to ensure accuracy of fit for subsequent modules.

In another step, the radiator module, which contains components such as the radiator, fan, air conditioning condenser, and other parts necessary for temperature control, is inserted into the already at least partially installed module carriers. The radiator module is aligned such that it fits exactly in the receptacles of the module carriers. The insertion frequently is carried out manually or with robot support in order to avoid damage and ensure precise positioning. Retaining clips, screws, or specialized fastening mechanisms secure the module to the carriers in order to ensure a solid connection and to minimize vibrations during vehicle operation.

In another step, functional interfaces of the radiator module can be connected to the corresponding couplings of the vehicle. These interfaces include the coolant hoses, electrical connections for fans and sensors, and air conditioning lines, among others. The coolant hoses are connected to the radiator and secured with, e.g., hose clamps in order to ensure a tight connection.

Electrical plug-in connections can be plugged in and checked for correct seating in order to ensure reliable energy supply and signal transmission.

Air conditioning lines for the air conditioning system can be connected with specialized couplings or screw connections that are sealed against the escape of refrigerant.

In the following step, the entire chassis frame, including the modules and carriers installed thereon, is connected to the body. This process connects the lower chassis unit to the upper structure of the vehicle. The body is positioned above the chassis assembly, often via lifting systems or robots.

The connection is accomplished at predetermined mounting points, here preferably by screwing the module carriers to the body at multiple points in order to form a stable and secure unit. The connections are checked for the correct preloading of the screws in order to ensure the structural integrity of the vehicle.

Finally, the module carriers that were initially mounted on the chassis frame are now also fixed in place on the body. This additional mounting provides an increased stiffness and a better load distribution between body and chassis frame.

The module carriers can be aligned on the mounting points of the body for this purpose.

Screws or other fasteners connect the carriers securely to the body structure. The connections can be checked to ensure that no stresses arise and that the components are seated precisely, which leads to improved overall quality and durability.

As a result, the same advantages arise with respect to a method according to the invention as have already been described with respect to a mounting arrangement according to the invention and/or a motor vehicle according to the invention.

It is possible according to the invention that the fitting of the radiator module includes a plugging-in of the radiator module in a first radiator module receptacle and an introduction and/or clipping-in of the radiator module in a second radiator module receptacle.

This step describes the precise integration of the radiator module into the module carriers, wherein the module is fixed in place by specific receptacles and mechanisms in order to ensure a stable and vibration-free position. The receptacles are designed such that they permit simple installation, while at the same time offering high stability and reliability. The first radiator module receptacle serves as the primary support and guide, which the radiator module is plugged into. This receptacle preferably is designed as a hole or bearing pin that securely receives the radiator module. The plug-in process is accomplished by a controlled sliding of the module into the receptacle. The geometry of the receptacle is designed such that it holds and guides the module securely with no clearance. Preferably, decoupling elements or decoupling element receptacles are provided in order to facilitate installation and to minimize vibrations. After plug-in into the first receptacle, the radiator module is introduced into the second receptacle. This second receptacle can include various fastening types, such as mechanical plug-in connections, clips, or latching mechanisms.

The radiator module can be pushed farther into the second receptacle until it reaches the final position. In this case, the module carrier according to the invention makes possible a precise installation in order to ensure proper fixing in place. Preferably, the fixing in place can be accomplished by clipping in, wherein specialized clips, latching projections, or snap-on connectors hold the modules in the receptacle securely and with little vibration. These clips frequently are made of plastics that are able to withstand loading or of metal, and are designed such that they are self-locking when inserted correctly. It is possible that additional retention elements such as screws or clamps are used in order to further stabilize the module, in particular in the case of modules subjected to higher loads.

This step thus makes it possible for the radiator module to not only be installed correctly and in a stable manner, but also to function reliably during vehicle operation, without being impaired by vibrations or thermal expansion.

Advantageously, a seal geometry can be installed on the radiator module in another step. The installation of a seal geometry on the radiator module is advantageous in order to ensure the functioning and efficiency of the module. These seals serve chiefly to seal against air flows, water, dust, and other contaminants that could impair cooling performance. In addition, they help to damp noise and to reduce vibrations. The seals preferably are made of flexible materials, such as EPDM (ethylene propylene diene monomer rubber), foam, or silicone, that have high elasticity and weather resistance.

Preferably, guide points or markings that facilitate correct positioning of the seal can be present on the bearing surfaces of the radiator module. In the case of complex geometries, specialized positioning aids or devices can also be employed. The seals are fixed in place on the radiator module with adhesive tapes or adhesives, for example. The adhesive tape used can adhere on both sides and has high adhesive power and temperature resistance. The adhesion process takes place in a precise manner to avoid wrinkling or air inclusions that could impair the sealing action. It is possible that the seals are clipped in and/or plugged in. For certain seal types, the mounting is accomplished by mechanical clip devices or plug-in projections. This type of installation is advantageous because it permits fast and tool-free installation and ensures a durable connection. Moreover, it is possible that screw connections can also be employed for more robust or large sealing elements in order to ensure additional mechanical retention.

A front end module of the motor vehicle can be installed or fitted onto the seal geometry of the radiator module in another step.

This step includes the final installation of the front end module on the radiator module. The front end module is a complex assembly that includes components such as the bumper, headlights, radiator grille, sensors, and holders. The connection of the front end module to the seal geometry of the radiator module provides efficient sealing, stability, and functional integration of the modules. The front end module is aligned to the predetermined attachment points of the module carriers. In this process, guide points, positioning aids, or specialized devices can help to position the modules precisely. The front end module is mounted mechanically on the radiator module or on the module carriers. This connection is accomplished by, e.g., screws, bolts, or special clips that are placed such that they do not impair the seal.

This step is advantageous, because a proper connection between the front end module and the seal geometry of the radiator module ensures not only the functionality, but also the aerodynamic efficiency and noise damping of the vehicle. The module carriers facilitate the installation and positioning of the front end module in this case.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 schematically shows an example of a module carrier according to the invention,

FIG. 2 schematically shows an example of a module carrier according to the invention,

FIG. 3 schematically shows an example of a mounting arrangement according to the invention,

FIG. 4 schematically shows an example of a mounting arrangement according to the invention,

FIG. 5 shows the example from FIG. 4 with a radiator module,

FIG. 6 shows the example from FIG. 4 and FIG. 5 with parts of a body,

FIG. 7 shows the example from FIG. 4, FIG. 5, and FIG. 6 with a front end module,

FIG. 8 shows an installed module carrier according to the example from FIG. 2,

FIG. 9 shows the example from FIG. 2 and FIG. 8 with a front end module and parts of a body, and

FIG. 10 schematically shows a motor vehicle with a radiator module and mounting arrangement according to the invention.

### DETAILED DESCRIPTION

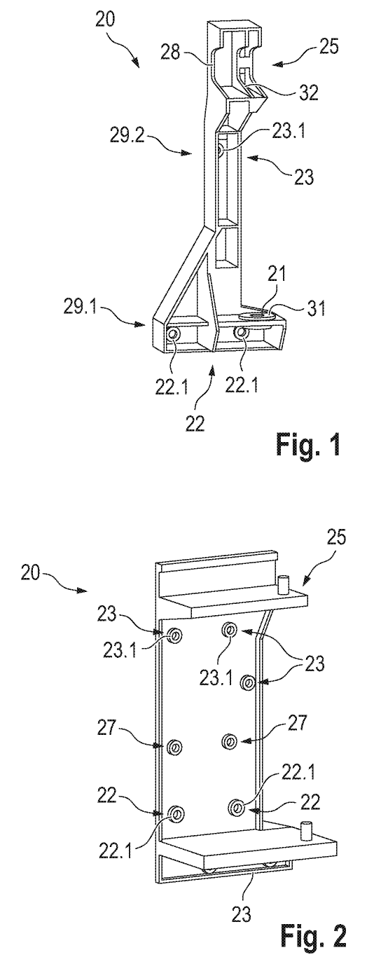

In FIG. 1, an example of a module carrier 20 according to the invention is shown. At least two module carriers 20 preferably are employed in a mounting arrangement 10 according to the invention. The module carrier 20 shown includes a first radiator module receptacle 21 and a second radiator module receptacle 25. The first radiator module receptacle 21 is arranged on a first arm 29.1 of the module carrier 20 and is designed as a hole. The radiator module receptacle 21 in this case has a decoupling element 31, which in the example shown is arranged in the hole and preferably is made of plastic. The first arm 29.1 is formed by a section of the module carrier 20 that extends horizontally. Also arranged on the first arm 29.1 is the first mounting section 22. The first mounting section 22 here, and preferably, has two receptacles 22.1. The receptacles 22.1 serve to attach the module carrier to the chassis frame, wherein fasteners that can be, e.g., screwed to the chassis frame can be arranged in the receptacles 22.1.

The module carrier 20 additionally has a second arm 29.2 that extends vertically from the first arm 29.1. The second arm 29.2 in this case includes the mounting section 23, via which the module carrier can be attached to a body of a motor vehicle. The second mounting section 23 has a receptacle 23.1, wherein a fastener that can be connected to a body of a motor vehicle can in turn be arranged in the receptacle 23.1. The second arm 29.2 additionally has the second radiator module receptacle 25 as well. In the example shown, the radiator module receptacle 25 includes a receiving jaw 28.

A receiving jaw 28 here preferably refers to a U-shaped opening, which serves as an entry point or docking point for a mating part with a complementary shape (on the radiator module). This opening preferably is designed such that the mating part can be introduced so as to fit precisely, at least in sections. The side walls of the U-profile offer guidance and retention for the mating part in this case. The mounting of the radiator module preferably is accomplished by mechanical locking mechanisms, by screw connections, or by clamping mechanisms, which permit a strong and stable connecting of the two parts. The receiving jaw 28 and the holder thus permit a mounting of the radiator module on the module carrier 20. In particular, the radiator module can be detachably or reversibly mountable. As a result, it can be removed easily for maintenance or replacement.

It is evident from FIG. 1 that installation of the radiator module on the module carrier 20 can be accomplished in a simple manner. Preferably, the radiator module is first arranged in the first radiator module receptacle 21 and held there. The weight of the radiator module then already rests on the module carrier 20, and a first positioning via the receptacle 21 has taken place. Following this, the radiator module is then fixed in place on the other radiator module receptacle 25. For this purpose, the module carrier 20 has a receiving jaw 28, in which a fastener or component of the radiator module can be arranged, in particular snapped into place. The radiator module is additionally fixed in place in its installation position by this means.

Another example of a module carrier 20 according to the invention from a mounting arrangement is shown in FIG. 2. The module carrier 20 includes two radiator module receptacles in each case, comparable to the example from FIG. 1. In the perspective shown, one radiator module receptacle 25 is located in the upper region of the module carrier 20 and one radiator module receptacle 21 in the lower region of the module carrier 20 here as well. The radiator module receptacles 21 and 25 in FIG. 2 can be both designed essentially the same or identically. In this case, the radiator module receptacles 21, 25 each have a bearing pin on which the radiator module can be arranged. In addition, the radiator module receptacles 21, 25 each include a platform-like section for arrangement of the radiator module. The bearing pins are arranged on the platform-like sections, wherein the sections 21, 25 extend orthogonally from the mounting sections 22 and 23.

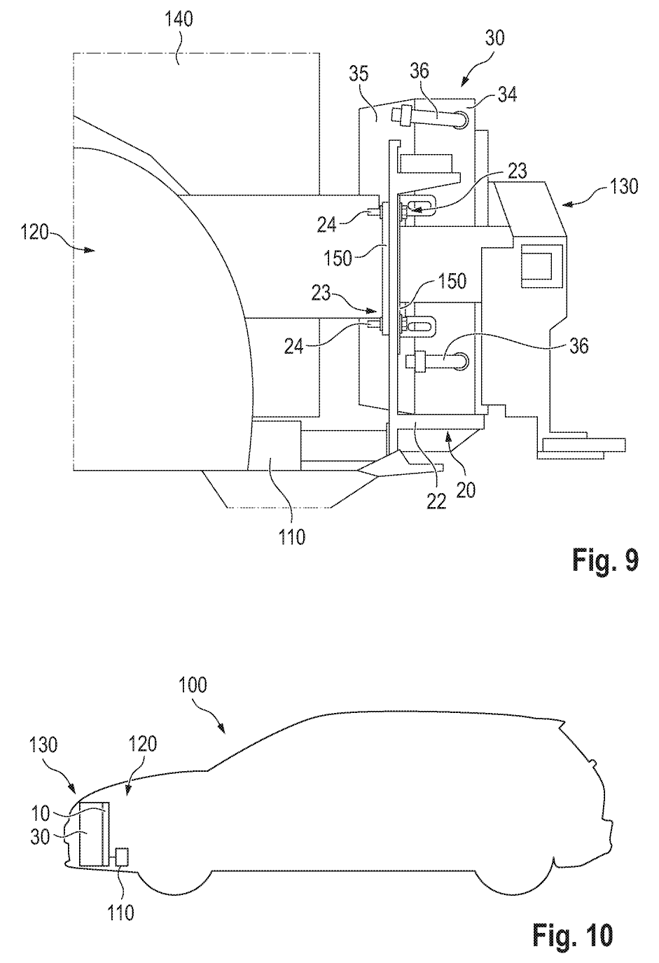

The module carrier 20 from FIG. 2 has numerous receptacles 22.1 and 23.1 and an interface 27 for a front end module. Below the first radiator module receptacle 21, the module carrier 20 includes a mounting section 23, via which the module carrier 20 can be installed on a chassis frame. Receptacles for fasteners are provided for this purpose so that the module carrier 20 can be, e.g., screwed to the chassis frame. The example is especially suitable for being installed between two bulkhead plates, as is explained in detail in FIG. 9.

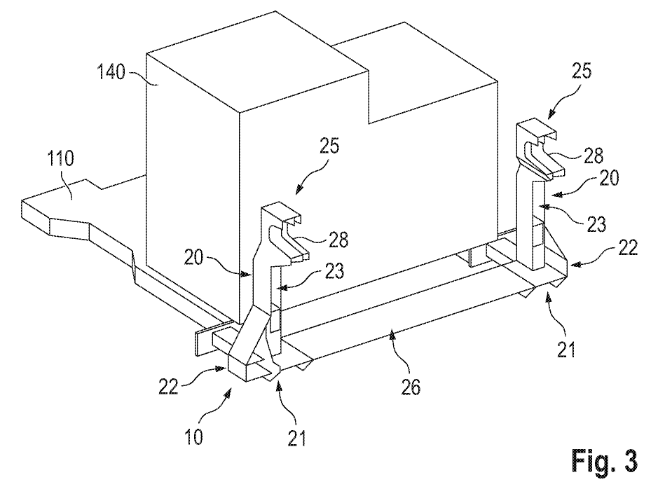

An example of a mounting arrangement 10 according to the invention is shown in FIG. 3. Here, the two module carriers 20 are connected to one another via a crosspiece 26. In addition, the module carriers 20 are connected to a chassis frame 110. The mounting sections 22 on the module carriers 20 serve this purpose. With the exception of the crosspiece 26, the module carriers 20 are designed identically to the module carrier from FIG. 1. Here, too, the module carriers have a receiving jaw 28, wherein the receiving jaw 28 is designed as a receptacle or positioning aid for the radiator module. The mounting sections 23 are arranged on the longitudinally extended and vertically running arm of the module in the middle section of the respective module carrier 20. The module carrier, and thus the entire module with chassis frame and drive unit 140, can be joined to a body of a motor vehicle via the mounting sections 23. The drive unit can be, for example, a motor or power electronics of a motor vehicle, which require effective cooling.

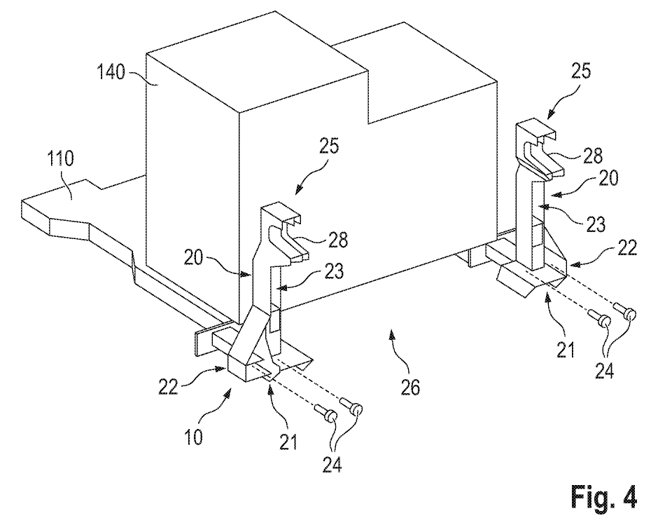

FIG. 4 shows an example of a mounting arrangement 10 according to the invention with two module carriers 20 that are arranged on a chassis frame 110. The two module carriers 20 are mounted on the first mounting section 22 of the respective module carrier 20 on the chassis frame 110 with the aid of the fasteners 24 for this purpose. In this case, and preferably, the fasteners 24 are designed as screws and are screwed to the chassis frame 110 through the receptacles for the fastener 24 on the module carrier 20 in the section 22. As a result, the mounting arrangement 10 is mounted on the chassis frame 110 in accordance with the first method step according to the invention. Provision can be made in this case, as is shown in FIG. 4, that the drive unit or the component to be cooled are [sic; should say “is”] already arranged on the chassis frame 110.

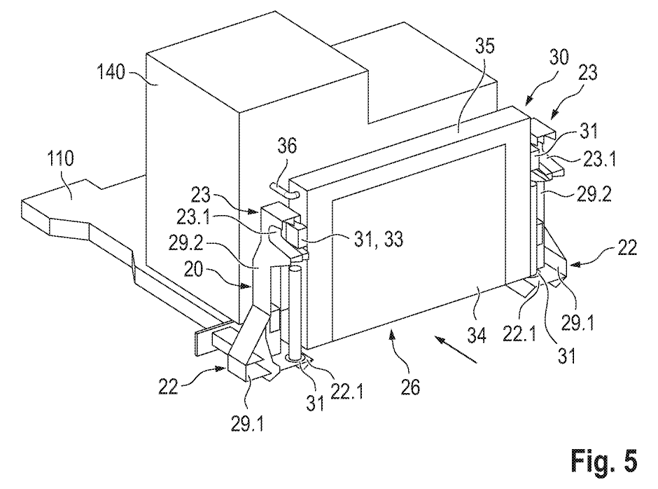

In FIG. 5, the module having the chassis frame 110, the unit 140, and the radiator module 30 is shown in the assembled state, the way it looks after the second method step. The radiator module 30 in this case is installed on the module carriers 20 and connected to the chassis frame 110 via the module carriers 20. The fitting of the radiator module 30 in the module carriers 20 preferably is accomplished in such a manner that first the radiator module 30 is placed in the receptacles 22.1 of the mounting sections 22. Consequently, the radiator module 30 is in retaining engagement with the module carrier 20, and the weight of the radiator module 30 can be at least partially accommodated by the module carriers 20. Arranged on each of the receptacles 22.1 are decoupling elements 31 so that unwanted vibrations or oscillations can be absorbed by the radiator module 30. Once the radiator module 30 is arranged in the receptacles 22.1 of the mounting section 22, the radiator module 30 is introduced into the receptacles 23.1 on the mounting sections 23. A receiving jaw 28, which simplifies introduction into the receptacles 23.1, is provided for this purpose. In addition, decoupling elements 31 are provided on the radiator module 30 or on the module carrier 20, on the receptacles 23.1. It is especially preferred that the decoupling elements 31 are connected to the module carrier 20 by a holder 33, in particular in the form of a snap-in and/or clip connection. The radiator module 30 is fixed in place on the module carriers 20 via the snapping-in or clipping.

The arrangement of the mounting sections 22 and 23 is chosen in accordance with the invention such that the sections 22 and 23 are arranged on the different arms 29.1 and 29.2 of the module carrier 20. In particular, the arrangement of the mounting sections 22 and 23 makes it possible that the radiator module 30 can be clipped or snapped into the receptacle 23.1 by a pivoting motion.

The radiator module 30 can include at least one heat sink 34, a fan 35, and functional interfaces 36 in this case. It is clearly evident that access to the interfaces 36 is easily possible owing to the inventive design and method steps. This is achieved, in particular, by the means that the radiator module 30 is not integrated in the front end module, but instead is attached to the chassis frame 110 independently thereof.

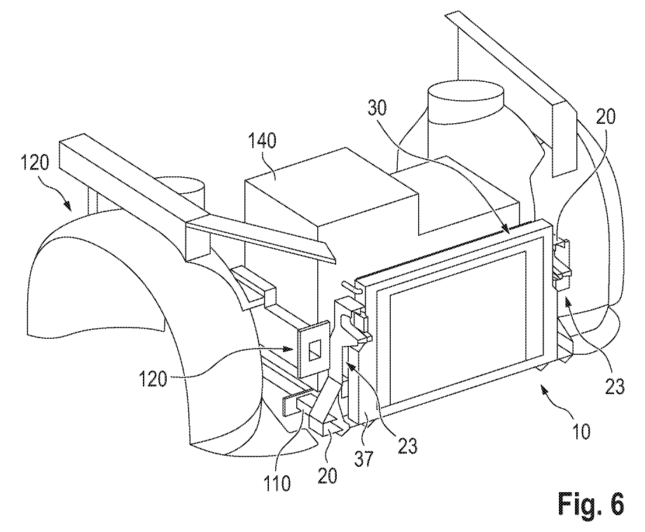

FIG. 6 shows an advanced state of assembly, wherein a body 120 of a motor vehicle and a seal geometry 37 on the radiator module 30 are additionally present. The module carriers 20 here correspond to the module carriers according to FIG. 1, 4, and 5. Depicted in particular is the way the module composed of chassis frame 110, unit 140, module carriers 20, and radiator module 30 is connected to the body 120. Preferably, the module is conveyed into the body 120 from below and then is connected thereto, in particular screwed thereto, at the module carriers 20. For this purpose, the module carriers have the second mounting sections 23. In the region of the mounting sections 23, the mounting arrangement 10 is preferably screwed to the body 120. As a result, the module composed of chassis frame 110, unit 140, module carriers 20, and radiator module 30 is additionally screwed to the body 120.

It is clearly evident in this stage of assembly, as well, that access to the interfaces 36 is easily possible owing to the inventive design and method steps. This is achieved, in particular, by the means that the radiator module 30 is not integrated in the front end module, but instead is attached to the chassis frame 110 independently thereof.

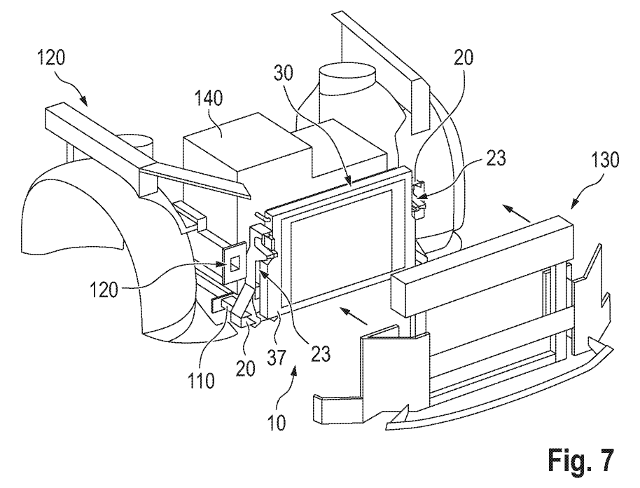

In FIG. 7, a front end module 130 is also shown in addition to the state shown in FIG. 6. The fact that the mounting arrangement 10 according to the invention simplifies and accelerates installation has already been described. This advantage is achieved, in particular, by the means that the module formation is adjusted. The radiator module 30 is not connected first to a front end module 130, but instead the front end module 130 is not installed until later, as shown in FIG. 7. Consequently, the functional interfaces of the radiator module are also freely accessible until this point in time, which simplifies and accelerates the attachment. The front end module 130 is placed on the module shown in FIG. 6 (body, chassis frame, radiator module), as the arrows show, and then connected thereto, in particular screwed thereto. The seal geometry 37 seals the interface of the front end module 130 and the radiator module 30 in this process.

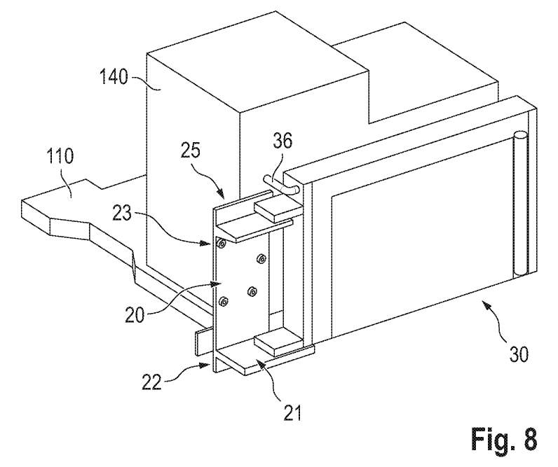

FIG. 8 shows a module carrier 20 according to the example from FIG. 2. Only a single module carrier 20 is shown. Two module carriers 20 can be provided (analogous to the first example). The module carrier 20 has two radiator module receptacles 21, 25 here as well. Each module carrier 20 includes two radiator module receptacles 21, 25, comparable to the example from FIG. 1. In the perspective shown, one radiator module receptacle 25 is located in the upper region of the module carrier 20 and one radiator module receptacle 21 in the lower region of the module carrier 20 here as well. The radiator module receptacles 21 and 25 in FIG. 2 are both designed essentially the same or identically. In this case, the radiator module receptacles 21, 25 each have a bearing pin on which the radiator module 30 is arranged. In addition, the radiator module receptacles 21, 25 each include a platform-like section for arrangement of the radiator module 30. Arranged on the platform-like sections are the bearing pins, wherein the sections 21, 25 extend orthogonally from the mounting sections 22 and 23. It is evident here, too, that installation of the radiator module 30 is possible in an uncomplicated manner. The radiator module 30 is placed on the radiator module receptacles 21, 25 and then connected. The functional interfaces 36 are freely accessible and can be connected in a simple manner to the unit 140 and/or the electrical system.

Shown in FIG. 9 is the assembled state, in which the body 120, the chassis frame 110, the radiator module 30, and the front end module 130 are connected to one another. The radiator module 30 includes at least one heat sink 34, a fan 35, and functional interfaces 36. The module carrier 20 in this case is arranged between the bulkhead plates 150, on the one hand of the front end module 130 and on the other hand in front of the body 120, and is screwed together via the fasteners 24 at the mounting section 23. Also evident is the way the front end module 130 in the mounting section 22 is additionally connected to the module carrier 20 and the chassis frame 110.

FIG. 10 shows a motor vehicle with a chassis frame 110 including drive unit 140 and a body 120 and also with a mounting arrangement 10 for attaching a radiator module 30 to the chassis frame 110 of the motor vehicle. The mounting arrangement 10 additionally makes possible simple attachment of a front end module 130 to the chassis frame 110 and to the body 120.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A mounting arrangement to attach a radiator module to a chassis frame of a motor vehicle, the mounting arrangement comprising:
at least two module carriers, each with at least one radiator module receptacle to support the radiator module on the module carriers;
a first mounting section to mount the module carriers on the chassis frame; and
a second mounting section to mount the module carriers on a body of the motor vehicle.

2. The mounting arrangement according to claim 1, wherein at least the first mounting section and/or the second mounting section has at least one receptacle for a fastener.

3. The mounting arrangement according to claim 1, wherein the module carriers have at least one second radiator module receptacle.

4. The mounting arrangement according to claim 3, wherein at least one of the radiator module receptacles has a decoupling element or a decoupling element receptacle.

5. The mounting arrangement according to claim 1, wherein the first mounting section forms a first arm and the second mounting section forms a second arm, and wherein the first arm is arranged orthogonally to the second arm so that an essentially T-shaped geometry is formed.

6. The mounting arrangement according to claim 1, wherein at least one of the radiator module receptacles is designed as a bearing pin or as a hole.

7. The mounting arrangement according to claim 1, wherein at least one of the radiator module receptacles has a receiving jaw, wherein a holder of the radiator module is adapted to be mounted in the receiving jaw.

8. The mounting arrangement according to claim 1, wherein the module carriers are connected to one another via a crosspiece.

9. The mounting arrangement according to claim 8, wherein the crosspiece has a supporting section for the radiator module, via which the radiator module is supported on the crosspiece.

10. The mounting arrangement according to claim 1, wherein the module carriers have an interface for mounting a front end module of the motor vehicle.

11. A motor vehicle comprising:
a chassis frame;
a body; and
the mounting arrangement according to claim 1 to attach a radiator module to the chassis frame of the motor vehicle.

12. A method for attaching a radiator module to a chassis frame of a motor vehicle, the comprising:
mounting the module carriers on the chassis frame via a first mounting section of the module carriers;
fitting the radiator module into the module carriers;
connecting functional interfaces of the radiator module to the motor vehicle;
connecting the chassis frame to a body of the motor vehicle; and
mounting the module carriers on the body of the motor vehicle via a second mounting section.

13. The method according to claim 12, wherein the fitting of the radiator module includes a plugging-in of the radiator module in a first radiator module receptacle and an introduction and/or clipping-in of the radiator module in a second radiator module receptacle.

14. The method according to claim 12, further comprising:
installing a seal geometry on the radiator module.

15. The method according to claim 12, further comprising:
fitting a front end module of the motor vehicle onto the seal geometry of the radiator module.
